(19) United States
(12) Patent Application Publication
(10) Pub. No.: US 2025/0200815 A1
(43) Pub. Date: Jun. 19, 2025

(54) UNSUPERVISED 3D POINT CLOUD DISTILLATION AND SEGMENTATION

(71) Applicant: InterDigital VC Holdings, Inc., Wilmington, DE (US)

(72) Inventors: Jiahao PANG, New York, NY (US); Min Young CHANG, Sunnyvale, CA (US); Dong TIAN, Wilmington, DE (US)

(21) Appl. No.: 18/846,639

(22) PCT Filed: Dec. 14, 2022
(86) PCT No.: PCT/US2022/052862

§ 371 Date: Sep. 12, 2024

Related U.S. Application Data
(60) Provisional application No. 63/319,610, filed on Mar. 14, 2022.

(51) Int. Cl. G06T 9/00

(52) U.S. Cl. CPC G06T 9/001; G06T 9/002

(57) ABSTRACT

In one implementation, we propose an unsupervised point cloud primitive learning method based on the principle of analysis by synthesis. In one example, the method uses a partitioning network and a point cloud autoencoder. The partitioning network partitions an input point cloud into a list of chunks. For each chunk, an encoder network of the autoencoder performs analysis to output a codeword in a feature space, and a decoder network performs synthesis to reconstruct the point cloud chunk. The reconstructed chunks are merged to output a fully reconstructed point cloud frame. By end-to-end training to minimize the mismatch between the original point cloud and the reconstructed point cloud, the autoencoder discovers primitive shapes in the point cloud data. During the network training, the parameters of the partitioning network and the autoencoder are updated. The trained modules can be applied to different applications, including segmentation, detection, and compression.

### TECHNICAL FIELD

The present embodiments generally relate to a method and an apparatus for compression, analysis, interpolation, representation and understanding of point cloud signals.

### BACKGROUND

The Point Cloud (PC) data format is a universal data format across several business domains, e.g., from autonomous driving, robotics, augmented reality/virtual reality (AR/VR), civil engineering, computer graphics, to the animation/movie industry. 3D LiDAR (Light Detection and Ranging) sensors have been deployed in self-driving cars, and affordable LiDAR sensors are released from Velodyne Velabit, Apple ipad Pro 2020 and Intel RealSense LiDAR camera L515. With advances in sensing technologies, 3D point cloud data becomes more practical than ever and is expected to be an ultimate enabler in the applications discussed herein.

### SUMMARY

According to an embodiment, a method is provided, comprising: accessing a chunk of points from an input point cloud; generating, by a first neural network-based module, a codeword that describes at least a shape in said point cloud chunk; reconstructing, by a second neural network-based module, said point cloud chunk based on said codeword; obtaining a mismatch metric based on said reconstructed point cloud chunk and said point cloud chunk; and adjusting parameters of said first neural network-based module and said second neural network-based module, based on said mismatch metric.

According to another embodiment, an apparatus is provided, comprising one or more processors and at least one memory coupled to said one or more processors, wherein said one or more processors are configured to access a chunk of points from an input point cloud; generate, by a first neural network-based module, a codeword that describes at least a shape in said point cloud chunk; reconstruct, by a second neural network-based module, said point cloud chunk based on said codeword; obtain a mismatch metric based on said reconstructed point cloud chunk and said point cloud chunk; and adjust parameters of said first neural network-based module and said second neural network-based module, based on said mismatch metric.

One or more embodiments also provide a computer program comprising instructions which when executed by one or more processors cause the one or more processors to perform the method according to any of the embodiments described herein. One or more of the present embodiments also provide a computer readable storage medium having stored thereon instructions for processing point cloud data according to the methods described herein.

One or more embodiments also provide a computer readable storage medium having stored thereon video data generated according to the methods described above. One or more embodiments also provide a method and apparatus for transmitting or receiving the video data generated according to the methods described herein.

### BRIEF DESCRIPTION OF THE DRAWINGS

FIG. 1 illustrates a block diagram of a system within which aspects of the present embodiments may be implemented.

FIG. 2 illustrates a method of primitive learning, according to an embodiment.

FIG. 3 illustrates PointNet as the encoder network.

FIG. 4 illustrates FoldingNet as the decoder network.

FIG. 5 illustrates a method of partition-based primitive learning, according to an embodiment.

FIG. 6 illustrates PointNet++ as the partitioning network.

FIG. 7 illustrates a method of generating primitives, according to an embodiment.

FIG. 8 illustrates a method of primitive learning for segmentation, according to an embodiment.

FIG. 9 illustrates a method of primitive learning for object detection, according to an embodiment.

FIG. 10 illustrates a method of primitive learning for PCC (encoder), according to an embodiment.

FIG. 11 illustrates a method of primitive learning for PCC (decoder), according to an embodiment.

### DETAILED DESCRIPTION

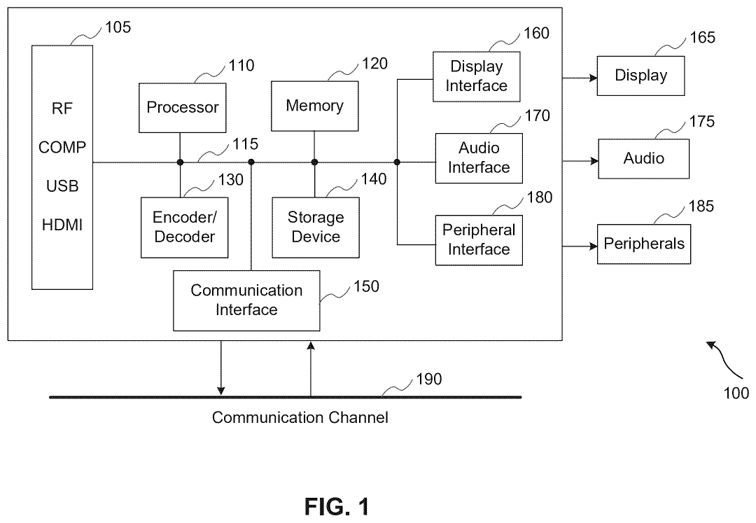

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, JPEG Pleno, MPEG-I, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing. Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

It is contemplated that point cloud data may consume a large portion of network traffic, e.g., among connected cars over 5G network, and immersive communications (VR/AR). Efficient representation formats are necessary for point cloud understanding and communication. In particular, raw point cloud data need to be properly organized and processed for the purposes of world modeling and sensing. Compression on raw point clouds is essential when storage and transmission of the data are required in the related scenarios.

Furthermore, point clouds may represent a sequential scan of the same scene, which contains multiple moving objects. They are called dynamic point clouds as compared to static point clouds captured from a static scene or static objects. Dynamic point clouds are typically organized into frames, with different frames being captured at different times. Dynamic point clouds may require the processing and compression to be in real-time or with low delay.

The automotive industry and autonomous car are domains in which point clouds may be used. Autonomous cars should be able to “probe” their environment to make good driving decisions based on the reality of their immediate surroundings. Typical sensors like LiDARs produce (dynamic) point clouds that are used by the perception engine. These point clouds are not intended to be viewed by human eyes and they are typically sparse, not necessarily colored, and dynamic with a high frequency of capture. They may have other attributes like the reflectance ratio provided by the LiDAR as this attribute is indicative of the material of the sensed object and may help in making a decision.

Virtual Reality (VR) and immersive worlds are foreseen by many as the future of 2D flat video. For VR and immersive worlds, a viewer is immersed in an environment all around the viewer, as opposed to standard TV where the viewer can only look at the virtual world in front of the viewer. There are several gradations in the immersivity depending on the freedom of the viewer in the environment. Point cloud is a good format candidate to distribute VR worlds. The point cloud for use in VR may be static or dynamic and are typically of average size, for example, no more than millions of points at a time.

Point clouds may also be used for various purposes such as culture heritage/buildings in which objects like statues or buildings are scanned in 3D in order to share the spatial configuration of the object without sending or visiting the object. Also, point clouds may also be used to ensure preservation of the knowledge of the object in case the object may be destroyed, for instance, a temple by an earthquake. Such point clouds are typically static, colored, and huge.

Another use case is in topography and cartography in which using 3D representations, maps are not limited to the plane and may include the relief. Google Maps is a good example of 3D maps but uses meshes instead of point clouds. Nevertheless, point clouds may be a suitable data format for 3D maps and such point clouds are typically static, colored, and huge.

World modeling and sensing via point clouds could be a useful technology to allow machines to gain knowledge about the 3D world around them for the applications discussed herein.

### Point Cloud Analysis and Understanding

3D point cloud data are essentially discrete samples on the surfaces of objects or scenes. To understand/analyze a point cloud scene consisting of multiple objects, one may perform different tasks such as segmentation, detection, and abstraction, etc.

Point cloud semantic segmentation refers to a label assignment problem for each individual point of a 3D point cloud with a class label. For example, given an indoor point cloud, a segmentation method needs to label the points as chair, desk, sofa, and so on. An advanced segmentation setting is referred to as instance segmentation, which tries to distinguish points between object instances within a point cloud. For example, there are two chairs, A and B, in a point cloud, then the instance segmentation method needs to segment the points between chair A and chair B.

Another important point cloud understanding task is object detection. With object detection, the task is to find out whether a target type of object exists in a scene. If detected, it further places rectangle bounding boxes tightly over the detected objects in a point cloud frame. A related task is called point cloud abstraction, where besides simple rectangle boxes used in detection, the algorithm uses varying shape primitives to fit objects/parts in an input point cloud. For example, basic building blocks of the 3D world being used include planes, spheres, ellipsoids, cones, or cylinders, etc.

Unfortunately, to train such learning-based 3D point cloud understanding modules, it typically needs a large amount of training data with ground-truth labels. This requirement leads to two main disadvantages. Firstly, it is costly to collect sufficient segmentation labels in practice. Secondly, such a segmentation algorithm driven by known labels would fail when faced with unseen data in the real world. In contrast, humans can perform the understanding tasks more in a self-supervision manner. When observing new scenes, humans progressively learn to discover new object classes and have them segmented, even if they have not been seen earlier.

The present application is directed to an unsupervised method for 3D point clouds data analysis and understanding. As described above, typical learning-based point cloud understanding systems require a large amount of labeled data to train the algorithm. However, it is costly to acquire sufficient labeled data. Additionally, such methods cannot be generalized to unseen data without new training labels. To resolve these limitations, we propose an unsupervised 3D point cloud abstraction method, which discovers similar/repetitive primitive shapes from an input 3D point cloud in a self-supervised manner. With the discovery of the primitives, our proposal can be applied to point cloud understanding problems such as segmentation and detection.

### Semantic Segmentation

The work PointNet is the first semantic segmentation algorithm that operates on native point clouds. PointNet uses a combination of pointwise MLP layers and global max pooling operators to obtain pointwise classification (segmentation) result. Subsequent works, such as PointNet++, DGCNN, KP-Conv, etc., extend PointNet to more complex point-based operations which count for the neighboring points and process an input point cloud hierarchically. They provide reasonably good semantic segmentation performance on not only object-level point cloud but also scene point clouds containing multiple objects.

However, these works all require a huge amount of labeled data for training. Consider that if it is necessary to deploy a segmentation algorithm to an unseen environment, e.g., we have a segmentation network trained for indoor scenes, but now we need to perform segmentation for outdoor scenes, then a straightforward solution is to apply the network trained in the original domain (indoor) directly to the new domain (outdoor). However, the discrepancy between the two domains may cause huge performance drop. Another solution is to collect new labels for the new domain, which can be very expensive, especially for large-scale point clouds containing millions of points and lots of objects.

To alleviate the above problem, the work PointContrast borrows the concept of transfer learning, which first conducts pretraining on a source dataset then finetunes on a smaller set of data from the target domain (with segmentation labels). On the other hand, some work performs training directly on a small set of labelled data in the target domain (a.k.a, weakly supervised learning). It is made possible by adding smoothness constraints to regularize the behavior of the network. However, all these methods still require ground-truth labels for training. Differently, our approach does not require any labels, and automatically discovers repetitive primitive shapes from the given point cloud dataset.

### Instance Segmentation and Object Detection

Instance segmentation for point cloud is also widely investigated, which needs to output the class label of the points and distinguish between different objects. To solve this task, the work SGPN (Similarity Group Proposal Network) deploys a single network to predict both point grouping proposal and a semantic class for each proposal. Differently, PointGroup uses a bottom-up strategy while focusing on exploiting the void space between objects. In the work DyCo3D, the authors proposed a dynamic approach to generate convolutional kernels for voxelized point cloud.

To perform object detection on point clouds, a representative work PointRCNN presents an object detection approach for raw point clouds. That is, the method does not require voxelizing a point cloud or being projected to a bird-eye view. Instead, it operates directly over raw point cloud. The method is composed of two steps. In a first step, a bottom-up strategy is applied to create 3D proposals. In a second step, local features are combined with global semantic features for each point and then to do box refinement and predict confidence levels.

We note that, all these existing works on instance segmentation and object detection require proper training labels to guarantee their success.

### Point Cloud Abstraction

Deep learning-based approaches have already been explored to deal with the challenges in point cloud abstraction. Existing point cloud abstraction methods use a set of predefined primitives (e.g., planes, spheres, cones) to represent objects.

Two main strategies in this regard pertain to supervised and unsupervised point cloud abstraction (PCA). Supervised PCA refers to the problem setting where the training process assumes access to ground truth information about the primitives and point memberships to the primitives. In contrast, unsupervised PCA only assumes access to the point cloud. Since it is quite expensive to obtain ground truth information in addition to the raw point cloud data, unsupervised point cloud processing approaches are preferred at some tolerable loss in performance.

Our proposal also works in an unsupervised manner, but is different from the above unsupervised PCA methods. Instead of using a set of predefined primitive shapes like the existing works, we directly summarize/discover/distill the representative primitive shapes from a given set of point cloud data.

In particular, we propose a point cloud abstraction method that we also call point cloud distillation. Given an input point cloud, our system outputs a set of primitives from the input point cloud using a neural network framework NNF in the inference stage. To achieve this goal, we propose a novel training strategy to obtain the network NNF, which is based on the principle of analysis by synthesis. The proposed NNF can be utilized for point cloud analysis/understanding such as instance segmentation, object detection, etc.

With existing point cloud abstraction approaches, their motivation was inspired by Paul Cezanne's saying in 1904, “. . . , treat nature by means of the cylinder, the sphere, the cone, everything brought into proper perspective . . . ”. Cezanne's insight indicates that an object can be conceived as assembled from a set of primitives. Such primitives are enumerated based on human's observation on the world. Point cloud abstraction approaches are then basically to fit the point cloud objects with the known primitives.

We begin this work with a more fundamental question: what could we do if the primitives are unknown? We think the discovery of primitives is a starting point for us to understand the 3D world. The primitives may refer to repetitive shape patterns. Simple primitives may be the cylinder, the sphere, the cone, etc. Advanced primitives may be objects in our world, for example, pedestrians, cars, trees, buildings, etc.

For example, imaging we live in a world that everything is composed of atomic elements with cubic-like shape, after observing the world for a sufficiently long time, we will obtain the concept of “cubic” shape. If the world is composed of sphere-like atomic shapes, instead, we will have the concept of “sphere” shape.

Hence, a target of this work is to enable the capability to discover a list of primitives by observing enough number of point cloud frames. The discovered primitives could benefit different downstream tasks (e.g., point cloud segmentation, detection, and compression) without additional training. For example, in the application of autonomous driving, once the algorithm discovers some common objects/primitives (e.g., cars, pedestrians) on a road, these concepts about a driving scene can be directly used for tasks such as detection, segmentation, so as to benefit the overall autonomous driving application.

### Primitive Learning

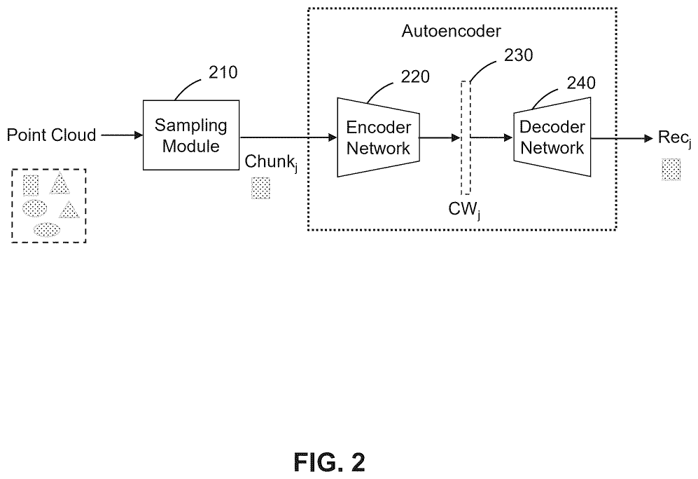

We propose an “analysis by synthesis” strategy to discover primitives that is based on an autoencoder framework. This procedure is shown in FIG. 2, according to an embodiment.

In this embodiment, a sampling module (210) takes “snapshots” on the input point cloud by sampling on it. It outputs a point cloud chunk—a subset of the points in an input point cloud. In one implementation, the sampling module (210) could fetch a random point cloud chunk, that is a point cloud chunk located at a random position with a random scale/size, and from a random point cloud frame in a point cloud dataset. For example, to generate the j-th point cloud chunk, the sampling module first selects a random position Pⱼ in 3D, then it selects a random radius rⱼ. For a point A in the point cloud, if it satisfies ∥A−Pⱼ∥₂≤rⱼ, i.e., the distance between A and Pⱼ is less than the radius rⱼ, then point A will be included in the j-th point cloud chunk.

For each “snapshot”, Chunkⱼ, the analysis step is performed by the encoder network (220) in the autoencoder. It extracts a codeword CWⱼ (230) in a feature space that describes a set of shapes. The synthesis step is conducted by the decoder network (240) in the autoencoder, that reconstructs the point cloud chunk, Chunkⱼ, from its codeword CWⱼ. After that, a mismatch metric between the reconstructed point cloud chunk and the original chunk is computed. During network training, the parameters of the encoder network (220) and the decoder network (240) are updated by minimizing the mismatch metric.

By iterating the analysis-synthesis process over observed point cloud chunks, it enables the autoencoder to gradually discover repetitive object shapes—primitives. Such an autoencoding process essentially becomes a primitive learning process which we also call point cloud distillation. The learned feature space, i.e., the output of the encoder network (220), is expected to characterize/summarize the few object shapes that appear most frequently.

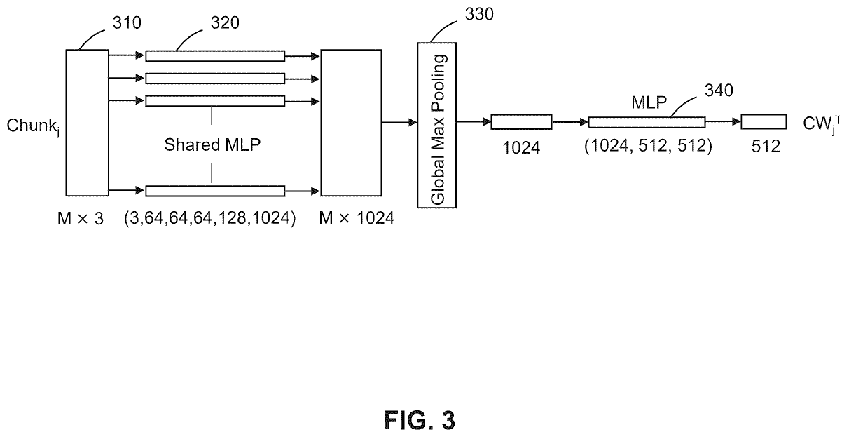

In one embodiment, the encoder network (220) can be implemented as a PointNet. FIG. 3 shows an example of the detailed architecture of PointNet, which takes the input point cloud chunk, Chunkⱼ, as input (310) and outputs the (transpose of the) codeword CWⱼ in the latent space. It is composed of a set of shared MLPs (320) operating on each 3D point, followed by the global max pooling operation (330) which extracts a global feature. It is further processed with another set of MLP layers (340), leading to the (transpose of the) output codeword CWⱼ.

Aside from PointNet, the encoder network can be other existing encoders for 3D point clouds. In one embodiment, the encoder network (220) can be implemented as the PointConv operator, which approximates convolution in the continuous domain. In another embodiment, the encoder network (200) can be implemented as the KPConv operator, which takes the neighboring points into consideration when computing the codewords.

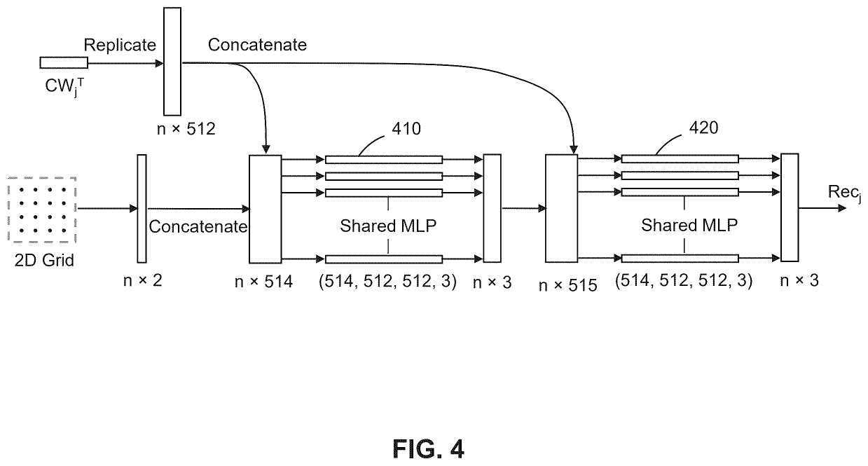

In one embodiment, the decoder network can be implemented as a FoldingNet, whose detailed design is shown in FIG. 4. It is composed of two series of shared MLP layers. First, the replicated codeword CWⱼ and the 2D grid are concatenated and fed to the first series of shared MLP layers (410). Next, the output from the first set of MLPs and the replicated CWⱼ are concatenated and processed by the second series of shared MLP layers (420), and the final reconstructed point cloud chunk Recⱼ has a dimension n×3 where n is the number of points.

We note that the decoder network can be implemented as other existing decoders for 3D point clouds. In one embodiment, the decoder network can be implemented as the LatentGAN decoder which simply consists of a series of MLP layers. In another embodiment, the decoder network can be a TearingNet which provides reconstructions that preserve the point cloud topology.

### Partitioning-Based Primitive Learning

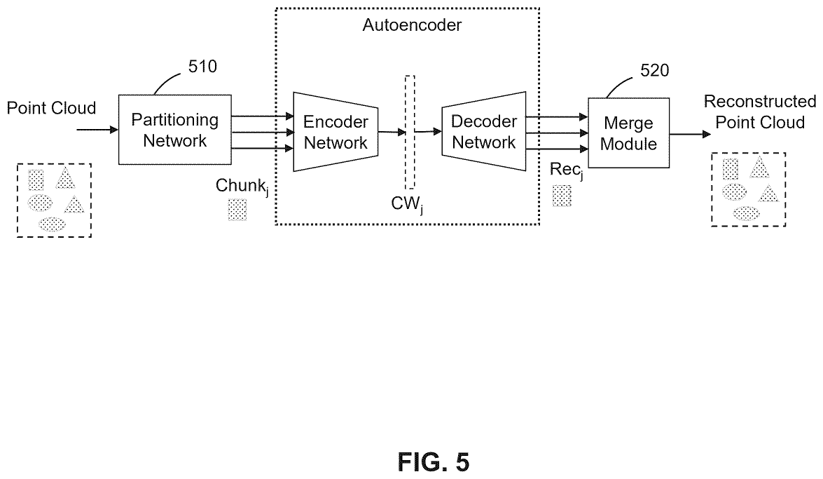

To make the primitive learning procedure more effective, in one embodiment, the sampling module is implemented by a point cloud segmentation/partitioning network (510) as shown in FIG. 5. The partitioning module is assumed to be a naïve point cloud segmentation network, that could output a list of point cloud chunks, e.g., Chunkⱼ with j=1, 2, . . . , K. The value of K can be constant or adaptive, depending on the partitioning network. In one embodiment, the partitioning network is a learnable neural network module, which can be end-to-end trained with the autoencoder network that followed.

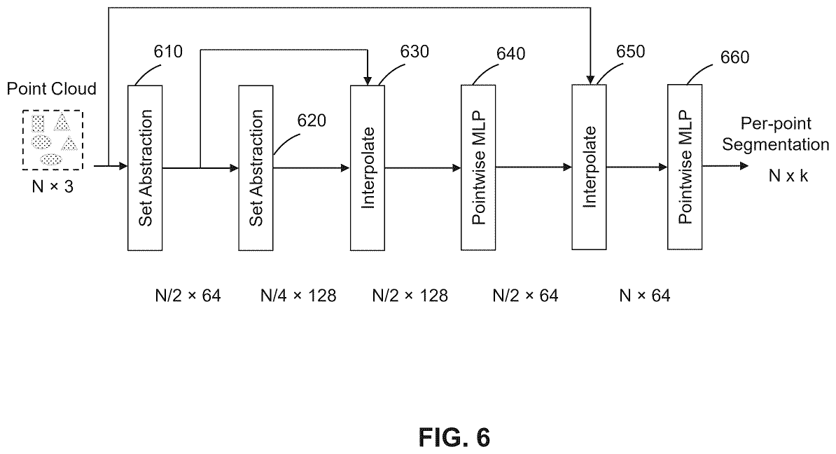

In one example, the partitioning network (510) can be implemented as a PointNet++, as shown in FIG. 6. The partitioning network consists of set abstraction layers (610, 620) which extract features for a subsampled set of points. A set abstraction layer consists of farthest point sampling (FPS) for sub-sampling and nearest neighbor search for grouping, followed by a PointNet for feature extraction. The PointNet++ architecture further consists of interpolation layers (630, 650) and pointwise MLP layers (640, 660) to gradually expand the subsampled point set and the associated features, such that the per-point segmentation results can be obtained at the end. In another implementation, the partitioning network (510) can be implemented as a VoteNet, which is a neural network architecture of 3D object detection or segmentation (see an article by Charles R Qi, et al., “Deep Hough voting for 3D object detection in point clouds”, in proceedings of the IEEE/CVF International Conference on Computer Vision, pp. 9277-9286, 2019).

Provided K point cloud partitions/chunks are output by the partitioning network, the autoencoder is iterated over each point cloud partition, Chunkⱼ, and the output point cloud partitions are merged (520) to output a fully reconstructed point cloud frame. Note that when the input point cloud is partitioned into chunks, the position information of the chunks is transmitted to the merge module in order to fully reconstruct the point cloud. Finally, a mismatch metric is computed between the reconstructed full point cloud and the input point cloud to supervise the neural network learning process. In one embodiment, the mismatch metric can be the Chamfer Distance (CD). In another embodiment, it can be the Earth Mover's Distance (EMD).

### Primitive Generation

Using the proposed primitive learning, the feature space of the codewords CW is expected to represent the primitives to be discovered. From the primitive feature space, we want to further generate a list of primitive shapes explicitly.

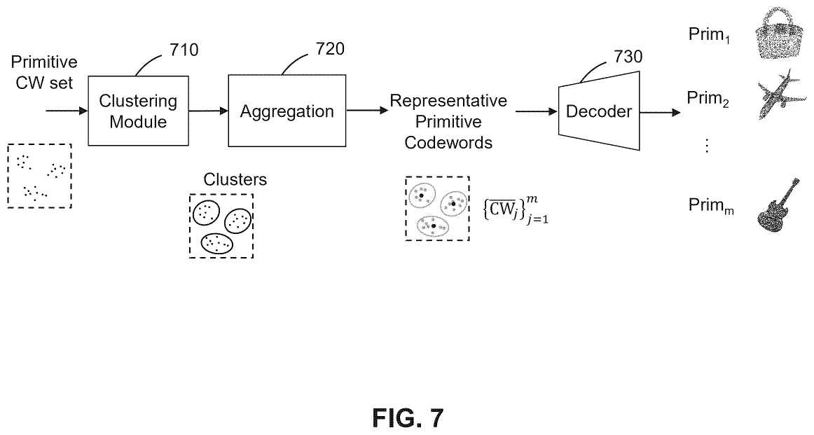

To be prepared, we would identify a set of codewords CWⱼ, whose associated point cloud chunks have a reconstruction quality beyond a certain threshold. The point cloud chunk of each identified CWⱼ is basically an instantiation from a primitive shape. With the codeword set, we aim to output the primitive shapes as shown in FIG. 7.

Firstly, because the codewords CWⱼ are high-level descriptions of the point cloud chunks, different point cloud chunks sampled from the same primitive should form a cluster in the feature space of CWⱼ. For example, different styles of chairs should have codewords that form a cluster, while different styles of cars should have codewords that form another cluster. Hence, if the codeword set goes through a clustering module (710), then each CWⱼ is assigned to one of a few (m) clusters. In one embodiment, the clustering module can be the DBSCAN algorithm. In another embodiment, k-means clustering can be adopted.

After that, aggregation (720) is performed to compute a representative codeword, C̅W̅, for each cluster/class. In one embodiment, the aggregation is performed by taking the average of the codewords in each cluster. Until now, we had m primitives/classes detected, with the corresponding representative codewords.

Lastly, to explicitly visualize the point cloud primitives, each representative primitive codeword is sent to the point cloud chunk decoder (730). The decoder module was trained during primitive learning. Hence, it will finally generate the primitive shapes we discovered.

### Segmentation

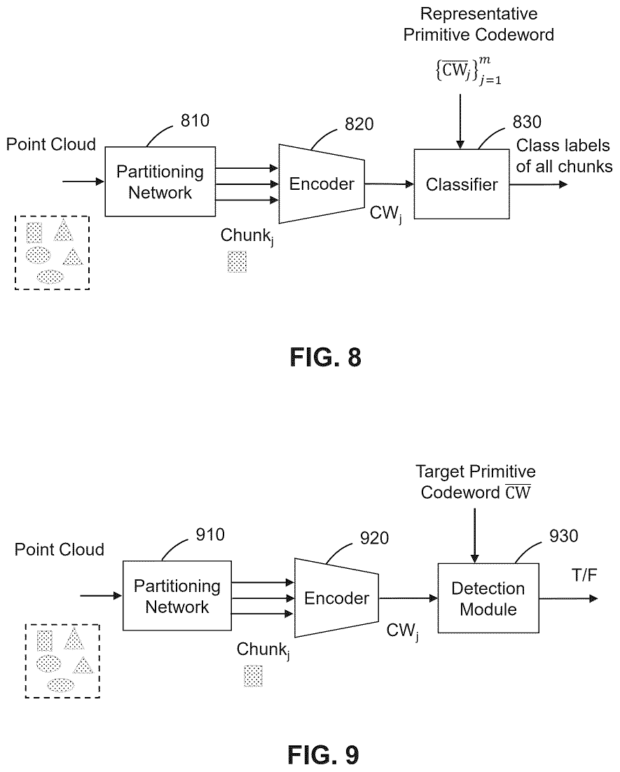

In this embodiment, we intend to use the learned primitives to assist a semantic segmentation process, as shown in FIG. 8. Suppose there is an input point cloud which may come from the training dataset or share similar characteristics as the training dataset, e.g., it is about the same type of scene as the training dataset, then this point cloud is first fed to the trained partitioning network (810), leading to a set of point cloud chunks. Then each point cloud chunk, Chunkⱼ, is fed to the trained encoder (820) to obtain the corresponding codeword CWⱼ. Then the codewords of the chunks are fed to a classifier (830), which classifies the codewords to one of the primitive classes based on the previously obtained primitive codewords {C̅W̅}. The output class labels of all the point cloud chunks together give the pointwise classification results of the overall point cloud, which is in fact, the segmentation result. In one embodiment, the classifier module (830) classifies each codeword based on its distance to each of the primitive codeword C̅W̅, i.e., it labels a codeword by the primitive class that is closest in the feature space.

Our proposal can be easily applied for instance segmentation because each point cloud chunk output by the partitioning module is essentially an instance. Specifically, each point in the input would not only be assigned a class label by the classifier, but also an instance label by the partitioning network. The instance labels help to distinguish two object instances even if they belong to the same primitive class.

### Object Detection

In this embodiment, we use the learned primitives to perform the detection task, as shown in FIG. 9. The goal of this detection pipeline is to determine whether a target primitive (with codeword C̅W̅) has appeared in an input point cloud.

Similar to the segmentation task, an input point cloud is first partitioned by the partitioning network (910) then fed to the encoder (920) to generate a set of codewords {CWⱼ}ⱼ₌₁^{K}. Next, a detection module (930) is introduced, which takes as input the set of codewords ({CWⱼ}ⱼ₌₁^{K}) and the codeword of the target primitive C̅W̅, then output a detection result: True or False. In one embodiment, the detection module (930) computes the distance between each codeword in {CWⱼ}ⱼ₌₁^{K} and C̅W̅. If the minimum of the computed distances is lower than a predefined threshold, implying that a point cloud chunk very similar to the target primitive appears in the input point cloud, then the detection module (930) would output “True” otherwise it would output “False”.

### Compression

In this embodiment, we use our proposal to assist a point cloud compression (PCC) process. A practical point cloud frame contains millions of points which can be too much for a point cloud codec to encode/decode in one pass due to the limitations in memory/computation. Thus, it is necessary to partition an input point cloud into several segments (or blocks) and encode/decode each partition individually. A naive approach is to divide the whole 3D space into cubes uniformly and view each cube as a block. However, this approach may put correlated 3D points into two different blocks and prevent the point cloud codec from utilizing their correlation for compression. For instance, an object is divided into two parts in two different blocks and the point cloud encoder cannot access both of them.

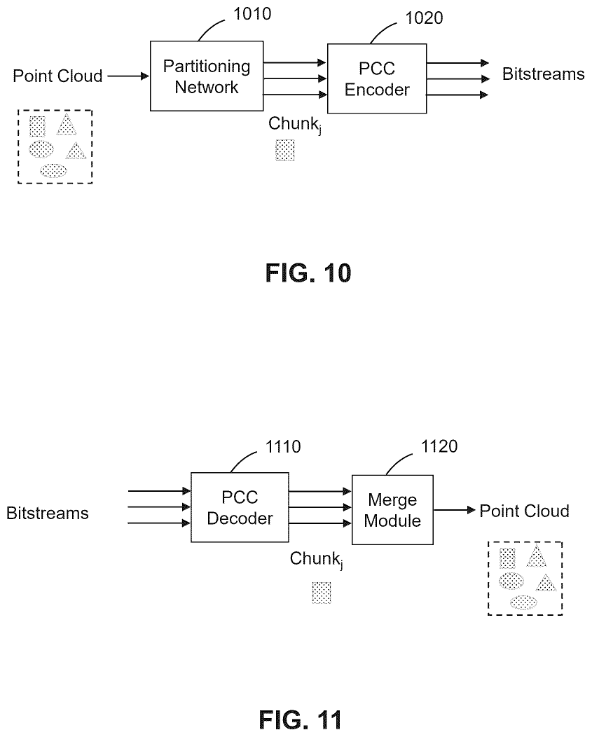

Differently, we propose to apply our method to partition an input point cloud frame. On the encoder side as illustrated in FIG. 10, we apply the trained point cloud partitioning network (1010) to divide an input point cloud frame into K partitions. Then each individual partition is fed to a PCC encoder (1020), resulting in K bitstreams. On the decoder side as illustrated in FIG. 11, the received bitstreams are first decoded by the PCC decoder (1110), the decoded K point cloud partitions are then merged by the merge module (1120), leading to the final decoded point cloud. Our approach discovers and preserves the primitive structures within each point cloud partitions. In other words, the points that are highly correlated will be grouped together within a partition. Thus, it lets the point cloud codec able to access the correlated points within each partition, and therefore improves the compression performance compared to the naive approach described above.

Various numeric values are used in the present application. The specific values are for example purposes and the aspects described are not limited to these specific values.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method, comprising:
partitioning an input point cloud into a plurality of chunks by a first neural network-based module;
for each chunk of points from said input point cloud:
generating, by a second neural network-based module, a respective codeword that describes at least a shape in said point cloud chunk, and
reconstructing, by a third neural network-based module, said point cloud chunk based on said codeword to form a respective reconstructed point cloud chunk;
reconstructing said input point cloud based on said respective reconstructed point cloud chunks;
obtaining a mismatch metric based on said reconstructed point cloud and said input point cloud; and
adjusting parameters of said first neural network-based module, said second neural network-based module, and said third neural network-based module, based on said mismatch metric.

2. The method of claim 1, wherein said point cloud chunk is a part of said input point cloud located at a random position with a random size in said input point cloud.

3. The method of claim 1, wherein said first neural network-based module corresponds to a PointNet.

4. The method of claim 1, wherein said second neural network-based module corresponds to a FoldingNet.

5. (canceled)

6. The method of claim 1, wherein said third neural network-based module corresponds to PointNet++ or VoteNet.

7. (canceled)

8. The method of claim 1, further comprising:
identifying a set of codewords from said respective codewords;
grouping said set of codewords into one or more clusters; and
obtaining a representative codeword for each cluster of said one or more clusters.

9. The method of claim 8, wherein said set of codewords are identified based on reconstruction quality of said plurality of reconstructed point cloud chunks.

10. The method of claim 8, further comprising:
reconstructing a primitive for a corresponding representative codeword, using said second neural network-based module.

11. The method of claim 1, further comprising:
performing classification on another point cloud based on said first and third neural network-based modules.

12. The method of claim 1, further comprising:
performing object detection on another point cloud based on said first and third neural network-based modules.

13. The method of claim 1, further comprising:
partitioning another point cloud into another plurality of point cloud chunks based on said first neural network-based module; and
encoding each of said plurality of point cloud chunks into one or more bitstream.

14. The method of claim 1, further comprising:
decoding one or more bitstreams to form another plurality of point cloud chunks; and
reconstructing another point cloud from said another plurality of point cloud chunks.

15-16. (canceled)

17. An apparatus, comprising one or more processors and at least one memory coupled to said one or more processors, wherein said one or more processors are configured to:
partition an input point cloud into a plurality of chunks by a first neural network-based module;
for each chunk of points from said input point cloud:
generate, by a second neural network-based module, a respective codeword that describes at least a shape in said point cloud chunk, and
reconstruct, by a third neural network-based module, said point cloud chunk based on said codeword to form a respective reconstructed point cloud chunk;
reconstructing said input point cloud based on said respective reconstructed point cloud chunks;
obtain a mismatch metric based on said reconstructed point cloud and said input point cloud; and
adjust parameters of said first neural network-based module, said second neural network-based module, and said third neural network-based module, based on said mismatch metric.

18. The apparatus of claim 17, wherein said one or more processors are further configured to:
identify a set of codewords from said respective codewords;
group said set of codewords into one or more clusters; and
obtain a representative codeword for each cluster of said one or more clusters.

19. The apparatus of claim 17, wherein said set of codewords are identified based on reconstruction quality of said plurality of reconstructed point cloud chunks.

20. The apparatus of claim 17, wherein said one or more processors are further configured to:
reconstruct a primitive for a corresponding representative codeword, using said second neural network-based module.

21. The apparatus of claim 17, wherein said one or more processors are further configured to:
perform classification on another point cloud based on said first and third neural network-based modules.

22. The apparatus of claim 17, wherein said one or more processors are further configured to:
perform object detection on another point cloud based on said first and third neural network-based modules.

23. The apparatus of claim 17, wherein said one or more processors are further configured to:
partition another point cloud into another plurality of point cloud chunks based on said first neural network-based module; and
encode each of said plurality of point cloud chunks into one or more bitstream.

24. The apparatus of claim 17, wherein said one or more processors are further configured to:
decode one or more bitstreams to form another plurality of point cloud chunks; and
reconstruct another point cloud from said another plurality of point cloud chunks.
